(19) United States
(12) Patent Application Publication
(10) Pub. No.: US 2012/0193925 A1
(43) Pub. Date: Aug. 2, 2012

(54) Clean-Burning Electrical Power Generating System

(76) Inventors: James Charles Juranitch, Ft. Lauderdale, FL (US); Thomas R. Juranitch, DelRay Beach, FL (US)

(21) Appl. No.: 13/203,227

(22) PCT Filed: Feb. 24, 2010
(86) PCT No.: PCT/US10/00565

§ 371 Date: Apr. 13, 2012

Related U.S. Application Data
(60) Provisional application No. 61/208,483, filed on Feb. 24, 2009.

(51) Int. Cl. H02K 7/18

(52) U.S. Cl. 290/1 R

(57) ABSTRACT

A system for generating electrical power employs a reactor for producing a product gas in response to the consumption of a feedstock. A heat reclamation arrangement employs a sodium heat pipe that communicates with the product gas the spent steam to extract heat from the product gas and thereby form heated steam. Heated steam is delivered to a turbine that has an input for receiving the heated steam, an outlet for exhausting spent steam, and a rotatory output. An electrical generator is coupled to the rotatory output of the turbine for producing the electrical energy. A recirculating system returns the spent steam to the heat reclamation arrangement. The fuel provided to the reactor may be any combination of coal, municipal solid waste, biomass, or a non-fossil fuel. Additives serve to neutralize the acid or base content of the product gas. A secondary power generation facility receives the product gas and produces additional electrical power.

### RELATIONSHIP TO OTHER APPLICATION

This application claims the benefit of the filing date of U.S. Provisional Patent Application Ser. No. 61/208,483 filed on Feb. 24, 2009, Confirmation No. 5941 (Foreign Filing License granted). The disclosure in the identified provisional patent application is incorporated herein by reference.

### BACKGROUND OF THE INVENTION

1. Field of the Invention

This invention relates generally to power generation systems, and more particularly, to an efficient, low polluting, power generation arrangement that operates continuously, can produce a variety of products, and can use a variety of fuels.

2. Description of the Related Art

Prior to the 1980's it was normal and considered good practice to design, build, and operate dedicated manufacturing plants for most every product that was produced on a large scale in the world. Shortly after that period many industries became enlightened to the merit of flexible machining, and flexible manufacturing. Much of this paradigm shift was accomplished on the back of the modern microprocessors. This device allowed more enlightened design, and more importantly complex and precise control of involved processes. Many new inventions were required in the wake of this manufacturing revolution. Instead of an assembly line in the past making only one dedicated product, current best in class assembly lines make up to 100's of different products and models, in batch sizes of one, with no perceived loss of productivity or additional set up time. This clever thought process, and design, has netted many benefits to industries like the automotive world, heavy duty engines, and other hard goods manufacturers.

The energy world has not yet embraced this concept. There is a need to produce energy products in a more efficient and cleaner process than any carbon based process presently in use. One implementation of this concept does not use fossil fuels. In another implementation, the use of fossil fuels (such as coal) is minimized where possible. This is essential in developed countries, such as the United States, that have an elevated need for a “clean coal” electricity generation system, and for the manufacture of other fossil fuel energy dependent products, such as plastics, gaseous fuels, and fertilizers. In the United States and other developed countries, there is an ongoing effort to reduce the dependence on imported oil. It is, therefore, an object of this invention to achieve these goals in an environmentally friendly way.

Current power generation plants have only one primary process; i.e., to produce electricity by burning fuel and consequently emitting pollutants, such as greenhouse gasses. One of the significant disadvantages of conventional power plants is that when they are brought off-line, and then restarted, they are unacceptably inefficient and produce excessive amounts of harmful emissions. Modern power plants do not enable the efficient throttling back of production of electrical power, and therefore they are operated continuously near the designed load limit. Since electrical power cannot be stored, power plants are frequently shut down and restarted in response to the varying demand for electrical power by consumers on a day-to-day basis, and as a result of differences in demand between day and night conditions.

With few exceptions (e.g., hydroelectric, wind, and nuclear power generation systems) power plants burn huge amounts of fossil fuel at relatively low efficiencies. The average efficiency of coal power plants in the United States is approximately 34%. Natural gas plants are slightly more efficient.

The predominant greenhouse gas produced by power plants is CO₂. In the present state of the art, coal plants in the United States produce on average approximately 2.01 Lbs of CO₂ per KWH of power. Natural gas and petroleum plants produce about 1.6 Lbs of CO₂ per KWH. These are “carbon positive” greenhouse gasses, in that they were removed from the ground and released to the atmosphere. In a carbon neutral process no new emissions are released into the atmosphere. In other words, nothing that has been removed from the ground is released into the atmosphere. Only existing carbon and greenhouse gasses that are already in circulation are processed and released.

In a carbon negative process greenhouse gasses are removed on a net basis from the atmosphere into a captured state. An example would be to extract CO₂ from the atmosphere and capture it into a hard substance, such as a plastic. A better product would be fertilizer since it could then be used to grow plants and food that continue to capture CO₂.

It is, therefore, an object of this invention to provide a power generation system that reclaims heat energy that otherwise would be exhausted into the atmosphere.

It is another object of this invention to provide a power generation system that operates at higher efficiency than conventional power generation systems.

It is also an object of this invention to provide a power generation system that eliminates the need for repeated start up and shut down procedures in response to consumer demand for power.

It is yet another object of this invention to provide a power generation system that greatly reduces emissions of CO₂.

### SUMMARY OF THE INVENTION

The foregoing and other objects are achieved by this invention which provides a system for generating electrical power. In accordance with the invention, the system employs a reactor for producing a product gas in response to the consumption of a feedstock. A heat reclamation arrangement extracts heat from the product gas and forms heated steam. The heated steam is delivered to a turbine that has an input for receiving the heated steam, an outlet for exhausting spent steam, and a rotatory output. An electrical generator is coupled to the rotatory output of the turbine for producing the electrical energy. In addition, a recirculating system returns the spent steam to the heat reclamation arrangement.

In one embodiment, there is provided in the recirculating system comprises a condenser arrangement.

The reactor is in certain embodiments of the invention provided with an excitation torch. A portion of the electrical energy produced by the electrical generator is conducted to the excitation torch.

Feedstock is provided to the reactor at a feedstock input. The feedstock may be coal, municipal solid waste, biomass, a non-fossil fuel, or any combination thereof. In addition, the reactor is provided with an additives input that receives additives that serve to neutralize the acid or base content of the product gas. In still further embodiments, the reactor is provided with a coke or other fuel input for receiving coke or other forms of fuel; and an air input for receiving air that in some embodiments may be oxygen enriched.

The heat reclamation arrangement, in some embodiments of the invention, is provided with a first duct having an inlet for receiving the product gas, and an outlet for exhausting the product gas at a reduced temperature. A second duct has an inlet for receiving the spent steam and an outlet for exhausting the heated steam. In addition, a heat transfer arrangement for conducting heat extracted from the product gas in the first duct to the spent steam in the second duct, to form the heated steam. In a further embodiment, the heat transfer arrangement includes at least one sodium heat pipe having a first end for communicating with the product gas in the first duct, and a second end for communicating with the spent steam in the second duct. Other heat transfer media besides sodium may be used. The sodium heat pipe has an envelope formed of stainless steel, Inconel, molybdenum, tungsten, niobium, a selectable combination of carbon and carbon composite; or Hastelloy X. A safety valve ensures safe operation.

In some embodiments of the invention, a heat transfer fin is disposed in the first duct for enhancing the transfer of heat from the product gas to the sodium heat pipe. Additionally, an adiabatic zone is, in some embodiments of the invention, interposed between the first and second ducts.

In still further embodiments of the invention the heat transfer arrangement is provided with a heat transfer loop having a first portion for communicating with the product gas in the first duct, and a second portion for communicating with the spent steam in the second duct. The heat transfer loop is a salt loop, and there is further provided a pump for circulating the salt along the salt loop.

In an alternative heat transfer arrangement, the heat transfer loop is a steam loop having a portion arranged to communicate with the product gas. The steam loop has an inlet for receiving the spent steam and an outlet for issuing the heated steam.

There is provided in some embodiments of the invention a Richardson reactor having an inlet for receiving the product gas at a reduced temperature, and an outlet for issuing selectable ones of C₂, C₃, C₄, and C₅. The Richardson reactor may be a Fischer Tropsch style reactor. The Richardson reactor is typically a foam reactor, and more specifically, in some embodiments of the invention is an alpha alumina oxide foam reactor. The foam reactor is, in some embodiments, optimized to provide higher carbon content transportation fuels, such as diesel fuel. In other embodiments there is provided a selectable combination of a Sabatier reactor having an inlet for receiving the product gas at a reduced temperature, and an outlet for issuing CH₄, an ammonia reactor having an inlet for receiving the product gas at a reduced temperature, and an outlet for issuing ammonia or NH₃, a methanol reactor having an inlet for receiving the product gas at a reduced temperature, and an outlet for issuing CH₃OH.

In still further embodiments, there is provided a secondary power generation facility having an inlet for receiving the product gas at a reduced temperature, and an outlet for issuing electrical power. The secondary power generation facility is provided with a compressor having an inlet for receiving the product gas at a reduced temperature, and an outlet for issuing a syngas. A first turbine receives the syngas, the first turbine having a rotatory output and an exhaust outlet. Additionally, a first generator coupled to the rotatory output of the first turbine, the first generator having an output for issuing electrical power. In some embodiments of the invention, a syngas cleaner is interposed between the outlet of the compressor and the first turbine.

In a further embodiment, there is provided a further heat reclamation arrangement that is arranged to communicate with the exhaust of the first turbine, the further heat reclamation arrangement having an outlet for producing a heated steam. A second turbine having a rotatory output is arranged to receive the heated steam from the further heat reclamation arrangement. Then, a second generator coupled to the rotatory output of the second turbine, and produces electrical power at an output thereof.

In accordance with a method aspect of the invention, there are provided the steps of:

delivering a feedstock to a reactor to produce a product gas;

reclaiming heat from the product gas in a heat reclamation arrangement to form a super heated steam;

delivering the superheated steam to a turbine;

rotating an electrical generator in response to the step of delivering the superheated steam to the turbine to produce electrical energy for an electrical distribution grid;

extracting spent steam from the turbine; and

recirculating the spent steam to the heat reclamation arrangement.

In one embodiment of this method aspect of the invention, and prior to performing the step of recirculating the spent steam to the heat reclamation arrangement, there is provided the step of subjecting the spent steam to a condensation process.

In some embodiments, there is provided the further step of delivering a portion of the electrical energy obtained during performance of the step of rotating the electrical generator, to a torch in the reactor.

The step of reclaiming heat from the product gas in a heat reclamation arrangement includes, in some embodiments, the further step of transferring heat along a sodium pipe between the product gas and the spent steam. In a different embodiment, the step of reclaiming heat from the product gas in a heat reclamation arrangement includes the further step of circulating the spent steam through a conduit disposed in communication with the product gas. In a still further method embodiment, the step of reclaiming heat from the product gas in a heat reclamation arrangement includes the further step of circulating a salt-based fluid through a conduit disposed in communication with the product gas and with the spent steam. In this still further method embodiment, the step of circulating a salt-based fluid includes the further step of pumping the salt-based fluid through the conduit.

The step of delivering the feedstock to the reactor includes the step of delivering coal, municipal solid waste, biomass, a fossil fuel, a non-fossil fuel, or any combination thereof to the reactor.

In an advantageous embodiment of the invention, the step of delivering the feedstock to the reactor to produce a product gas is performed continuously independently of the demand for electrical power on the electrical distribution grid. Thus, the reactor is not repeatedly started and shut down in response to demand on the electrical distribution grid. The reactor is, in some embodiments of the invention, operated in a pyrolysis mode.

In other embodiments of the method aspect of the invention, there is provided the further step of delivering coke or other fuel to the reactor. In yet other embodiments, there is provided the further step of delivering air to the reactor, the air optionally being enriched with O₂. In still further embodiments, there is provided the step of delivering an additive to the reactor, the step of delivering an additive to the reactor being responsive to a chemical characteristic of the product gas.

In an advantageous embodiment of the invention the reactor is a plasma reactor.

In respective embodiments of the invention there are provided the steps of operating:

a Fischer Tropsch style reactor for making a product in response to a decreased demand for electrical power by the electrical distribution grid;

a Richardson reactor for making a product in response to a decreased demand for electrical power by the electrical distribution grid;

a Sabatier reactor for making a product in response to a decreased demand for electrical power by the electrical distribution grid;

an ammonia process for making a product in response to a decreased demand for electrical power by the electrical distribution grid; and

a methanol process for making a product in response to a decreased demand for electrical power by the electrical distribution grid.

In a further advantageous embodiment, there is provided the step of operating a secondary electrical generation arrangement that produces additional electrical power in response to an increased demand for electrical power by the electrical distribution grid. In accordance with the invention, the step of operating a secondary electrical generation arrangement is performed in response to the production of the product gas by the reactor.

### BRIEF DESCRIPTION OF THE DRAWING

Comprehension of the invention is facilitated by reading the following detailed description, in conjunction with the annexed drawing, in which:

FIG. 1 is a simplified schematic representation of a primary plant process and arrangement constructed in accordance with the principles of the invention;

FIGS. 2a and 2b are a simplified schematic representations of a high temperature heat reclamation arrangement constructed in accordance with the principles of the invention;

FIG. 3 is a simplified schematic representation of a molten salt heat reclamation system that is useful in the practice of the invention;

FIG. 4 is a simplified schematic representation of a direct-acting high pressure steam system that is useful in the practice of the invention; and

FIG. 5 is a simplified schematic representation of a prior art combined cycle generator system that is useful in the practice of a specific illustrative embodiment of the invention.

### DETAILED DESCRIPTION

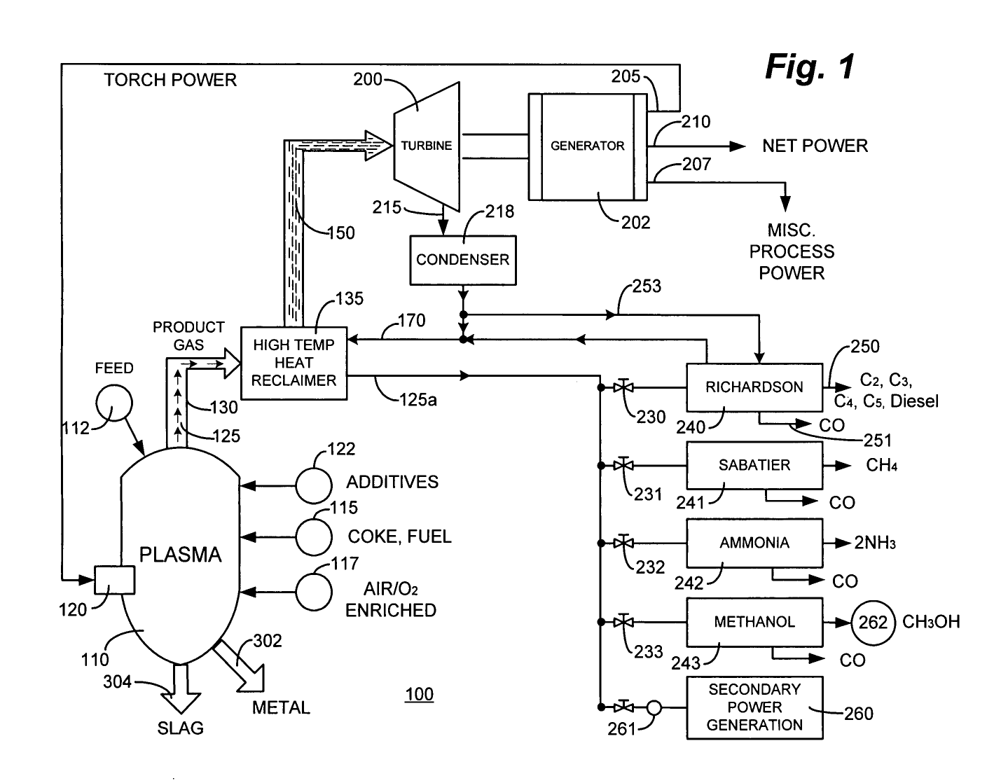

FIG. 1 is a simplified schematic representation of a primary plant system 100 constructed in accordance with the principles of the invention. As shown in this figure, a plasma reactor 110 will process a feedstock 112 that in this specific illustrative embodiment of the invention can consist of 100% coal or other fossil fuel, 100% municipal solid waste (MSW), 100% biomass, or any combination thereof. Other heat sources other than plasma could be used in the practice of the invention. In this embodiment, feedstock coke 115, or other fuel, can optionally be used. Feedstock air, or oxygen enriched air 117, also optionally may be delivered to plasma reactor 110.

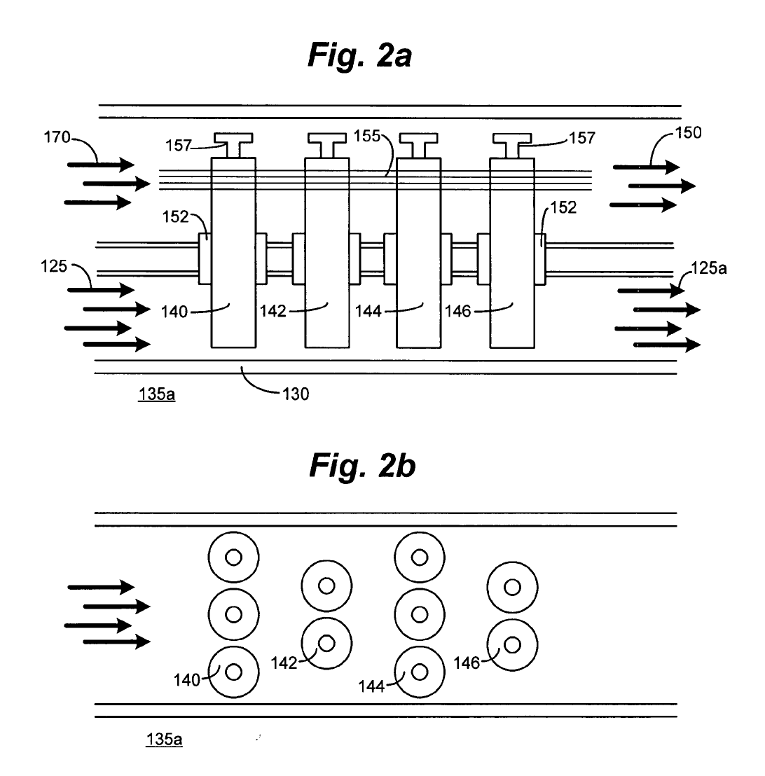

Direct or indirect acting plasma torches 120 are used in this specific illustrative embodiment of the invention to excite plasma reactor 110. In a preferred mode of operation plasma reactor 110 is operated in a pyrolysis mode with compressed MSW as the feedstock. However, plasma reactor 110 can be operated in a non pyrolysis mode in the practice of the invention. Additives 122 are optionally delivered to plasma reactor 110 to neutralize the acid or base content (not specifically designated) of a product gas 125 that is conducted along an outlet duct 130. Product gas 125 exits the plasma reactor at approximately 1250° C., and approximately 27% of the total energy that is present in product gas 125 from the plasma reactor 110 primarily is in the form of sensible heat. Due to the extreme temperature and composition of product gas 125, most of the heat energy has heretofore usually been wasted. The present invention includes within its scope several methods of utilizing this energy more effectively. In this embodiment, the heat contained in product gas 125 is recovered in a high temperature heat reclamation system 135, that is described in greater detail in FIGS. 2a and 2b.

FIGS. 2a and 2b are a simplified schematic representations of an illustrative high temperature heat reclamation system 135a constructed in accordance with the principles of the invention. Elements of structure that have previously been discussed are similarly designated. Referring for the moment to FIG. 2a, which is a side representation of high temperature heat reclamation system 135, product gas 125 is shown to flow along outlet duct 130. In this embodiment, there is provided high temperature heat reclamation system 135a that uses heat pipes, such as sodium heat pipes 140, 142, 144, and 146. The heat pipes are design to transfer and capture the energy in product gas 125. Basic heat pipes are known in the prior art, and are described in U.S. Pat. No. 2,350,348 that issued to R. S. Gaugler on Jun. 6, 1944, and assigned to General Motors. At approximately 1250° C., product gas 125 impinges upon the heat pipes. These very efficient heat transfer devices with no moving parts are optimized to operate at different temperatures depending on the working material and the envelope material that is employed in a practicable embodiment. For example, in embodiments of the invention that employ sodium (not shown) as the working phase change material, and one of a number of possible envelope materials (not specifically designated), such as stainless steel, Inconel, molybdenum, tungsten, niobium, carbon-carbon composite, or Hastelloy X, heat is transferred in the pressure range necessary for super heated or super critical steam (i.e., ≧3,200 PSI) which is designated as heated/super critical steam 150 in FIGS. 1 and 2a. Heated/super critical steam 150 constitutes, in this embodiment, an energy elevation of return steam 170.

Referring once again to FIG. 2a, an adiabatic zone 152 is interposed between each of sodium heat pipes 140, 142, 144, and 146. There is additionally provided a finned heat transfer zone 155 to enhance heat transfer to the steam. A plurality of rupture discs 157 are provided (associated with respective ones of the heat pipes in this embodiment) to enable fail safe operation of the heat pipes. FIG. 2b is a top view representation of high temperature heat reclamation system 135 showing the arrangement of heat pipes 140, 142, 144, and 146, as well as additional heat pipes that are not specifically designated.

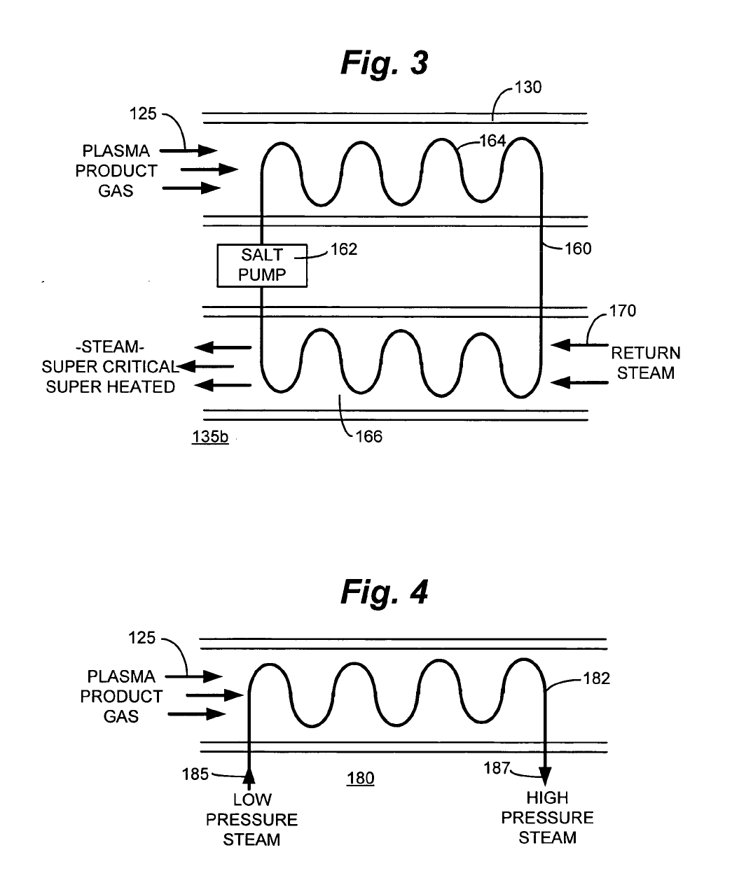

FIG. 3 is a simplified schematic representation of a molten salt heat reclamation system 135b that is useful in the practice of the invention. Elements of structure that have previously been discussed are similarly designated. At least a portion of the technology represented in this figure has been generated as a result of the now known Generation IV nuclear reactor development. In this embodiment, a molten salt working fluid loop 160 is pumped through a salt pump 162. A carbon-carbon composite heat exchanger 164 extracts heat energy from product gas 125. The heat energy is transferred to a heat exchanger 166 and applied to return steam 170, which is then issued as heated/super critical steam 150.

FIG. 4 is a simplified schematic representation of a direct-acting high pressure steam system 180 that is useful in the practice of the invention. In this embodiment, a high temperature direct acting heat exchanger 182 is in contact with product gas 125. High temperature direct acting heat exchanger 182 is, in this embodiment of the invention, formed of Hastelloy, carbon-carbon, or other suitable high temperature alloy. Low pressure steam 185 enters high temperature direct acting heat exchanger 182, absorbs heat, and is transformed into high pressure steam 187.

Referring once again to FIG. 1, it is shown that heated/super critical steam 150 is piped to a steam turbine 200. Steam turbine 200 is coupled to rotate a generator 202 to produce electrical energy at an electrical output 205 that is used to operate plasma torches 120. A further electrical output 207 issues electrical energy that is used to operate miscellaneous process systems (not specifically designated), and a net carbon free electrical output 210 from generator 202 constitutes net power to the distribution grid (not shown).

In a 2,500 Ton per Day (TPD) MSW plant the net continuous carbon free electrical output from this stage would be approximately 31 MW. Spent steam 215 is returned through a condenser 218, and is recharged through high temperature heat reclamation system 135, as previously described.

It is noteworthy that the generated electrical power is actually carbon negative in this application since the typical make up of MSW contains significant amounts of biomass that captures CO₂ from the atmosphere prior to being processed in plasma reactor 110. Additional greenhouse gas credits are produced due to the avoidance of escaping gaseous pollution from landfills. Pure biomass will produce greater power with reduced greenhouse gas emissions.

At the other extreme of the feedstock 112 scale is coal with an illustrative BTU content of approximately 14,120 btu/lb. If coal is used as feedstock 112 in a 2,500 TPD plant, the net electrical output 210 of this stage will be approximately 90 MW. This power is carbon free since no exhaust gas is released to the atmosphere in the production of the power. A combination of biomass, MSW, and coal will produce a proportionate amount of net electrical energy 210.

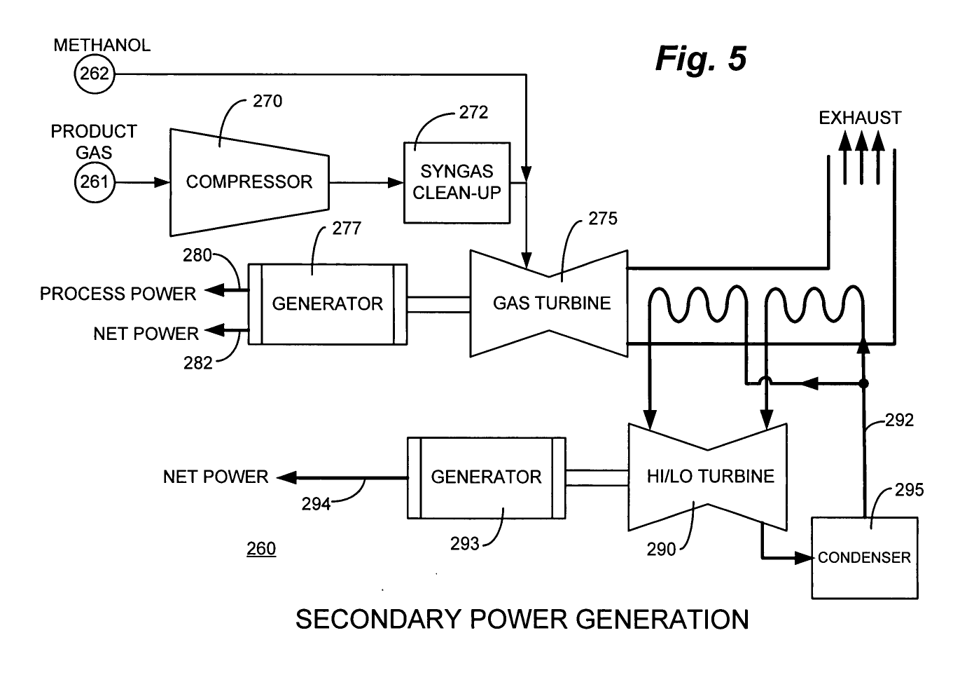

Product gas 125a that has been passed through high temperature heat reclamation system 135 is routed, in this specific illustrative embodiment of the invention, through control valves 230-233 to produce various products. It is to be noted that plant system 100 can employ one or more, in any combination, of reactors 240-243. In this embodiment of the invention, methanol reactor 243 issues CH₃OH at an output 262 thereof, which as will be described in connection with FIG. 5, is delivered to a gas turbine 275. In addition, and referring once again to FIG. 1, some embodiments of the invention are provided with a secondary power generation system 260 that receives a portion of product gas 125a via a control valve 261. An illustrative secondary power generation system 260 is described below in connection with FIG. 5.

Referring once again to FIG. 1, product gas 125a that is issued by high temperature heat reclamation system 135 is routed, in this specific illustrative embodiment of the invention, through a Richardson reactor 240, which in some embodiments is a Fischer Tropsch style reactor during off-peak electrical generation hours (e.g., at night). During the off-peak operating periods, a base amount of carbon free, or carbon negative electrical energy is sent to the grid through generator 202. The product gas is directed to selectively make C₂, C₃, C₄, C₅, and other products 250 such as plastic feed stocks and diesel fuel through Richardson Reactor 240. A relatively smaller amount of CO product gas 251 is collected and sold for industrial use or product feed stock, such as detergents and polycarbonates. The CO product gas 251 can also be gas shifted (not shown) to produce more hydrogen and more products 250 with a slight release of carbon neutral CO₂ or carbon positive CO₂, depending on which feed stock 112 is being used.

Each of reactors 240-243 reclaim any heat possible as shown in steam loop 253. The additional steam loops to the balance of the reactors have not been shown for clarity. A Sabatier Reactor 241 produces CH₄ as its output product. An ammonia process 242 produces feed stock for fertilizer or munitions, and a methanol reactor 243 produces methanol as its output product, specifically CH₃OH, at an output 262.

During peak electrical demand hours reactors 240-243 are bypassed and product gas 125a is directed to secondary power generation system 260. A conventional combined cycle power plant is represented in FIG. 5. In some embodiments, methanol is directed to the combine cycle power plant.

FIG. 5 is a simplified schematic representation of a prior art combined cycle generator system that is useful in the practice of a specific illustrative embodiment of the invention. Elements of structure that have previously been discussed are similarly designated. Modern best in class combined cycle power plants operate at up to 60% efficiency. As shown in this figure, there is provided a gas compressor 270 that receives a portion of product gas 125a at a node 261 (see, FIG. 1), and is coupled at its output to a syngas conditioning system 272, which in this embodiment serves to clean the syngas. The cleaned syngas is delivered to a gas turbine generator 275 that is coupled to a generator 277. In this specific illustrative embodiment of the invention, gas turbine generator 275 additionally receives methanol from an input node 262 (see, FIG. 1) that is connected to the output of methanol reactor 243. Generator 277 produces at an electrical output 280 electrical energy that is used to operate miscellaneous process systems (not specifically designated). Net power to the distribution grid (not shown) is provided at electrical output 282.

A secondary steam turbine 290 is shown in this figure with an associated heat reclamation system 292. The heat reclamation system in this embodiment of the invention has incorporated therewith a condenser 295 that receives the exhaust (not specifically designated) of secondary steam turbine 290. Net carbon neutral or carbon negative electrical energy produced at 2,500 TPD of MSW from combined outputs 282 and 294 is ˜146 MW. When combined with output 210 of carbon free power the plant nets ˜177 MW of peak continuous power in a carbon negative mode of operation.

When operated on coal as the feedstock, the coal carbon positive output 282 and 294 combined is ˜383 MW. This power is produced at about 0.94 lbs CO₂ per KWh or 223% cleaner than today's normal coal power plant. When the carbon free plant power 210 is added, the total plant peak continuous electrical output is increased to 473 MW at 0.64 Lbs CO₂ per KWh which is approximately 328% cleaner than conventional coal power plants and approximately 205% better than the natural gas power plants in use today. These values are based on the flexible manufacturing assumptions of twelve hours per day of plastic production (or any other product) plus production of the plant's electrical base output from steam turbine 200, (electrical output 210, shown in FIG. 1) and twelve hours during which the plant produces only electricity. At full electrical production both outputs 282 and 294 from combined cycle power generators 277 and 293, respectively, and output 210 from generator 202 are summed together. The analysis herein presented does not consider the additional savings in CO₂ that is achieved by plasma reactor 110 remaining hot 24 hours a day. No start up or shut down procedures are needed during peak or off peak hours. The overall plant fuel to electricity conversion efficiency is approximately 49.4% which is approximately 24% better than any known coal power plant, and 47% better than typical coal power plants that are currently being operated in the United States. This superior efficiency includes the added losses for cleaner emissions.

Additional benefits of the present flexible manufacturing system include the output of a slag outlet 304 (FIG. 1) that can be converted into rock wool insulation (not shown). This type of insulation is characterized with a higher insulating factor than conventional fiberglass systems, and is produced essentially resource and energy free in this manufacturing system. Thus, additional energy savings are achieved in every building in which this insulation it is installed. In addition to the foregoing, reclaimed metals 302 (not specifically shown) are obtained from plasma reactor 110 and will serve to reduce overall consumption of energy and to reduce pollution.

Although the invention has been described in terms of specific embodiments and applications, persons skilled in the art may, in light of this teaching, generate additional embodiments without exceeding the scope or departing from the spirit of the invention described herein. Accordingly, it is to be understood that the drawing and description in this disclosure are proffered to facilitate comprehension of the invention, and should not be construed to limit the scope thereof.

1. A system for generating electrical power, the system comprising:
a reactor for producing a product gas in response to the consumption of a feedstock;
a heat reclamation arrangement for extracting heat from the product gas and forming heated steam;
a turbine having an input for receiving the heated steam, an outlet for exhausting spent steam, and a rotatory output;
an electrical generator coupled to the rotatory output of said turbine for producing electrical energy; and
a recirculating system for returning the spent steam to said heat reclamation arrangement.

2. The system of claim 1, wherein said reactor is provided with a feedstock input for receiving a fossil fuel.

3. The system of claim 2, wherein said fossil fuel is coal.

4. The system of claim 1, wherein said reactor is provided with a feedstock input for receiving municipal solid waste.

5. The system of claim 1, wherein said reactor is provided with a feedstock input for receiving biomass.

6. The system of claim 1, wherein said reactor is provided with a fuel input for receiving a fuel.

7. The system of claim 6, wherein said fuel is a selectable combination of coke, methane, and propane.

8. The system of claim 1, wherein said reactor is provided with an air input for receiving air.

9. The system of claim 8, wherein the air is oxygen enriched air.

10. The system of claim 1, wherein said heat reclamation arrangement comprises:
a first duct having an inlet for receiving the product gas, and an outlet for exhausting the product gas at a reduced temperature;
a second duct having an inlet for receiving the spent steam and an outlet for exhausting the heated steam; and
a heat transfer arrangement for conducting heat extracted from the product gas in said first duct to the spent steam in said second duct, to form the heated steam.

11. The system of claim 10, wherein said heat transfer arrangement comprises a phase change medium.

12. The system of claim 11, wherein said phase change medium comprises a heat pipe having a first end for communicating with the product gas in said first duct, and a second end for communicating with the spent steam in said second duct.

13. The system of claim 12, wherein there is further provided a heat transfer fin in said first duct for enhancing the transfer of heat from the product gas to said heat pipe.

14. The system of claim 12, wherein there is further provided an adiabatic zone interposed between said first and second ducts.

15. The system of claim 12, wherein said heat pipe comprises an envelope formed of stainless steel.

16. The system of claim 15, wherein said heat pipe is a sodium heat pipe

17. The system of claim 12, wherein said heat pipe comprises an envelope formed of Inconel.

18. The system of claim 12, wherein said heat pipe comprises an envelope formed of molybdenum.

19. The system of claim 12, wherein said heat pipe comprises an envelope formed of tungsten.

20. The system of claim 12, wherein said heat pipe comprises an envelope formed of niobium.

21. The system of claim 12, wherein said heat pipe comprises an envelope formed of a selectable combination of carbon and carbon composite.

22. The system of claim 12, wherein said heat pipe comprises an envelope formed of Hastelloy X.

23. The system of claim 12, wherein said heat pipe is provided with a safety valve for ensuring safe operation.

24. The system of claim 1, wherein said heat transfer arrangement comprises a heat transfer loop having a first portion for communicating with the product gas in said first duct, and a second portion for communicating with the spent steam in said second duct.

25. The system of claim 24, wherein said heat transfer loop is a salt loop, and there is further provided a pump for circulating salt along said salt loop.

26. The system of claim 1, wherein said heat transfer loop is a steam loop having a portion arranged to communicate with the product gas, said steam loop having an inlet for receiving the spent steam and an outlet for issuing the heated steam.

27. The system of claim 10, wherein there is further provided a Richardson reactor having an inlet for receiving the product gas at a reduced temperature, and an outlet for issuing selectable ones of C₂, C₃, C₄, C₅, and diesel fuel.

28. The system of claim 27, wherein said Richardson reactor is a Fischer Tropsch style reactor.

29. The system of claim 27, wherein said Richardson reactor is a foam style reactor.

30. The system of claim 27, wherein said Richardson reactor is an alpha alumina oxide foam style reactor.

31. The system of claim 10, wherein there is further provided a Sabatier reactor having an inlet for receiving the product gas at a reduced temperature, and an outlet for issuing CH₄.

32. The system of claim 10, wherein there is further provided an ammonia reactor having an inlet for receiving the product gas at a reduced temperature, and an outlet for issuing NH₃.

33. The system of claim 10, wherein there is further provided a methanol reactor having an inlet for receiving the product gas at a reduced temperature, and an outlet for issuing CH₃OH.

34. The system of claim 10, wherein there is further provided an inlet for receiving methanol.

35. The system of claim 10, wherein there is further provided a secondary power generation facility having an inlet for receiving the product gas at a reduced temperature, and an outlet for issuing electrical power.

36. The system of claim 35, wherein said secondary power generation facility comprises:
a compressor having an inlet for receiving the product gas at a reduced temperature, and an outlet for issuing a syngas;
a first turbine for receiving the syngas, said first turbine having a rotatory output and an exhaust outlet; and
a first generator coupled to the rotatory output of said first turbine, said first generator having an output for issuing electrical power.

37. The system of claim 36, wherein there is further provided a syngas cleaner interposed between the outlet of said compressor and said first turbine.

38. The system of claim 36, wherein there are further provided:
a further heat reclamation arrangement arranged to communicate with the exhaust of said first turbine, said further heat reclamation arrangement having an outlet for producing a heated steam;
a second turbine having a rotatory output and arranged to receive the heated steam from said further heat reclamation arrangement; and
a second generator coupled to the rotatory output of said second turbine, said second generator having an output for issuing electrical power.

39. A method of operating an electrical power plant, the method comprising the steps of:
delivering a feedstock to a reactor to produce a product gas;
reclaiming heat from the product gas in a heat reclamation arrangement to form a super heated steam;
delivering the superheated steam to a turbine;
rotating an electrical generator in response to said step of delivering the superheated steam to the turbine to produce electrical energy for an electrical distribution grid;
extracting spent steam from the turbine; and
recirculating the spent steam to the heat reclamation arrangement.

40. The method of claim 39, wherein there is further provided the step of delivering methanol to the turbine.

41. The method of claim 39, wherein said step of reclaiming heat from the product gas in a heat reclamation arrangement comprises the further step of transferring heat along a heat pipe between the product gas and the spent steam.

42. The method of claim 39, wherein said step of reclaiming heat from the product gas in a heat reclamation arrangement comprises the further step of circulating the spent steam through a conduit disposed in communication with the product gas.

43. The method of claim 39, wherein said step of reclaiming heat from the product gas in a heat reclamation arrangement comprises the further step of circulating a salt-based fluid through a conduit disposed in communication with the product gas and with the spent steam.

44. The method of claim 43, wherein said step of circulating a salt-based fluid comprises the further step of pumping the salt-based fluid through the conduit.

45. The method of claim 39, wherein said step of delivering the feedstock to the reactor comprises the step of delivering a fossil fuel to the reactor.

46. The method of claim 45, wherein said fossil fuel is coal.

47. The method of claim 39, wherein said step of delivering the feedstock to the reactor comprises the step of delivering municipal solid waste to the reactor.

48. The method of claim 39, wherein said step of delivering the feedstock to the reactor comprises the step of delivering biomass to the reactor.

49. The method of claim 39, wherein said step of delivering the feedstock to the reactor comprises the step of delivering a selectable combination of coal, municipal solid waste, and biomass to the reactor.

50. The method of claim 39, wherein said step of delivering the feedstock to the reactor comprises the step of delivering a non-fossil fuel to the reactor.

51. The method of claim 39, wherein said step of delivering the feedstock to the reactor to produce a product gas is performed continuously independently of the demand for electrical power on the electrical distribution grid.

52. The method of claim 39, wherein there is provided the further step of operating the reactor in a pyrolysis mode.

53. The method of claim 39, wherein there is provided the further step of delivering a selectable combination of coke, methane, propane, and natural gas to the reactor.

54. The method of claim 39, wherein there is provided the further step of delivering air to the reactor.

55. The method of claim 54, wherein the air is enriched with O₂.

56. The method of claim 39, wherein there is provided the further step of delivering an additive to the reactor, said step of delivering an additive to the reactor being responsive to a chemical characteristic of the product gas.

57. The method of claim 39, wherein the reactor is a plasma reactor.

58. The method of claim 39, wherein there is provided the step of operating a Fischer Tropsch style reactor for making a product in response to a decreased demand for electrical power by the electrical distribution grid.

59. The method of claim 39, wherein there is provided the step of operating a Richardson reactor for making a product in response to a decreased demand for electrical power by the electrical distribution grid.

60. The method of claim 39, wherein there is provided the step of operating a Sabatier reactor for making a product in response to a decreased demand for electrical power by the electrical distribution grid.

61. The method of claim 39, wherein there is provided the step of operating an ammonia process for making a product in response to a decreased demand for electrical power by the electrical distribution grid.

62. The method of claim 39, wherein there is provided the step of operating a methanol process for making a product in response to a decreased demand for electrical power by the electrical distribution grid.

63. The method of claim 39, wherein there is provided the step of operating a secondary electrical generation arrangement for producing additional electrical power in response to an increased demand for electrical power by the electrical distribution grid.

64. The method of claim 63, wherein said step of operating a secondary electrical generation arrangement is performed in response to the production of the product gas by the reactor.
